(19) United States
(12) Patent Application Publication
(10) Pub. No.: US 2012/0266740 A1
(43) Pub. Date: Oct. 25, 2012

(54) OPTICAL ELECTRIC GUITAR TRANSDUCER AND MIDI GUITAR CONTROLLER

(76) Inventors: Nathan Hilbish, Bedford, VA (US); Afroditi Vennie Filippas, Henrico, VA (US); Lee Stewart, Chester, VA (US); Andrew Good, Midlothian, VA (US)

(21) Appl. No.: 13/451,124

(22) Filed: Apr. 19, 2012

Related U.S. Application Data
(60) Provisional application No. 61/476,791, filed on Apr. 19, 2011.
(60) Provisional application No. 61/623,853, filed on Apr. 13, 2012.

(51) Int. Cl. G10H 3/06; G10H 7/00

(52) U.S. Cl. 84/645; 84/724

(57) ABSTRACT

Photodiodes in combination with an amplifier of transimpedance configuration provides an optical vibration detector having a linear frequency response with a light emitter and sensor of sufficiently small size to be inserted between strings of a musical instrument in order to provide signals suitable for amplification. The frequencies of vibrating strings of a musical instrument can be converted in accordance with either of two converter embodiments to control a music synthesizer, an automatic music transcription arrangement or the like.

### CROSS-REFERENCE TO RELATED APPLICATIONS

This application claims benefit of priority of U.S. Provisional Applications 61/476,791, filed Apr. 19, 2011 and 61/623,853. filed Apr. 13, 2012, which are hereby incorporated by reference in their entirety.

### FIELD OF THE INVENTION

The present invention generally relates to vibration transducers and, more particularly, to vibrations transducers for developing electrical signals corresponding to the vibrations of planes or strings which are particularly applicable to stringed musical instruments, particularly for amplification and control of other waveform processing such as by a music synthesizer.

### BACKGROUND OF THE INVENTION

Virtually all human cultures have developed devices of various types for making sounds for communication, signaling or aesthetic purposes. Among the most popular types of such devices are those which create controllable sound through the vibration of one or more strings. In general, stringed instruments comprise a structure for placing a string in tension and include a structure generally referred to as a bridge which supports the string at an intermediate point and defining one end of the vibrational length of the string to transfer the vibration of the string to a membrane or other surface, sometime part of a resonating structure, to increase the surface at which the vibration is coupled to the surrounding air. The other end of the vibrational length of the string is established by another support structure (sometimes referred to as a nut) for the string or a mechanism such as is used in some types of harp. In many string instruments, the vibrational length of the string can be modified by manually pressing an intermediate point on the string against another portion of the stringed instrument such as a so-called fingerboard or fretboard to establish a desired frequency of vibration or pitch produced by the string when it vibrates after being excited in some manner such as by plucking or strumming the string, bowing (e.g. rubbing a slightly adhesive material against the string to produce a substantially continuous sound) or by a mechanism that provides stretching, striking or plucking of the string.

Stringed instruments have been developed to have a large number of traditional shapes and sizes as well as different complements of strings which can be tuned to desired combinations of musical pitches or, in some instruments, to resonate with other notes or their harmonics (sometimes referred to as drone strings) to provide a wide variety of sound qualities. By the same token, the area of the instrument to which the string vibration is coupled and the properties thereof in regard to propagation of the string vibration therein as well as the acoustic qualities of any resonator structure largely determines the maximum volume of sound (e.g. the maximum energy that can be coupled to the surrounding air) to be propagated to the listener that can be produced by the instrument as well as the various qualities of the sound.

Since the practical size of the instrument is largely determined by the range of frequency or pitch it is to produce and the geometry of a vibrating string is limited by desirable vibrational modes, the volume of sound that can be produced by a single stringed instrument is often quite limited, leading, for example, to much greater numbers of stringed instruments than wind or percussion instruments and greater numbers of smaller, higher-pitched string instruments than larger, lower-pitched string instruments in orchestras and other musical ensembles.

However, many stringed instruments are used in performances by relatively small groups of musicians for relatively large audiences in large auditoriums or outdoor venues where electronic sound amplification is needed. In such circumstances it is important to capture only sounds from desired sources (e.g. voices or individual instruments) using individual transducers (in the case of musical instruments, sometimes referred to as pick-ups) in a highly selective manner so that suitable amplification or other audio signal processing of the signals from individual sources can be independently provided. While microphone-type transducers having relatively narrow reception angles or patterns may be suitable for voices, such transducer are less than optimal for stringed instruments since they do not adequately discriminate the sounds of the instrument from other ambient sounds. Therefore, it has been the traditional practice to directly detect the vibration of the strings of stringed instruments with electromagnetic transducers if electronic sound amplification is to be provided.

Additionally, once the vibration of the strings has been converted to an electrical signal suitable for electronic amplification, many qualities of the sound produced can be readily altered by suitable processing of the electrical signal. In general, for some musical styles, the more modification of the electrical signal representing the string vibration that is available, the less important the acoustic properties of the instrument will be. For this reason and others such as durability and the ease of mounting electromagnetic transducers thereon, so-called solid-body guitars and basses have become the standard for use in many popular music groups.

As a closely related issue, so-called music synthesizers are devices that can provide many different effects in modifying the waveform of an electrical signal to obtain a wide variety of different sounds by, for example, modifying the amplitude and phase of harmonic content of a waveform and the envelope of the waveform, either generally or over the duration of a tone. While early music synthesizers were complex special-purpose devices, at the present state of the art, their functions can be emulated by computers of relatively modest computing power and a number of software programs are commercially available to achieve such functions. Many music synthesizers intended for real time, live performance are controlled from a keyboard to provide input as to the musical notes upon which the synthesizer is to operate. However, many musician who might wish to have the wide gamut of audio effects of which music synthesizers are capable may not be as facile or well-trained for use of a keyboard as they might be in regard to other instruments and stringed instruments in particular which requires an entirely differ type of physical dexterity than is required for a musical keyboard instrument.

On the other hand, for other musical styles, retaining the subtle qualities of the sound of particular instruments may be of high importance. In this regard, electromagnetic transducers cause damping of string vibrations due to the attraction of the string to the magnetic field of the transducer as the string moves through it and significantly alters the sound qualities of stringed instruments. Moreover, electromagnetic transducers have a non-linear frequency response and require the use of steel strings on the instrument; the former being somewhat amenable to approximate electrical compensation while the latter is not and would significantly alter the quality of sound if, in fact, the instrument is of a sufficiently robust structure to tolerate the installation of steel strings. Additionally, electromagnetic transducers are susceptible to noise from ambient electrical fields including, importantly, 60 Hz noise from electrical power distribution mains.

Attempts to avoid some of the problems associated with electromagnetic vibration transducer have involved phototransistors. However, those attempts have not been particularly successful since phototransistors also have a non-linear response to light intensity due to the DC gain being a function of the collector current which has a non-linear relationship to the base current where the base current is a function of the light incident on the base junction which varies with frequency (and possibly the amplitude) of the vibration of a string. (For this reason, phototransistors are better suited for and more frequently used in switching circuits and wireless remote control arrangements.) Moreover, use of phototransistors as transducers for string vibrations are susceptible to interference from ambient light which may change rapidly and repeatedly during a performance, due either to particular lighting effects that may also be used during a performance or even by being shadowed due to the motions of the performer.

### SUMMARY OF THE INVENTION

It is therefore an object of the present invention to provide an optical transducer for string vibration that exhibits a linear frequency response and can be constructed in a modular form that can be easily attached to a wide variety of string instruments in a manner that does not interfere with the playing of the instrument or significantly alter the acoustic properties of the instrument.

It is another object of the invention to provide a vibration transducer that can be applied to virtually any vibrating system and which has minimal effect on the vibrating system being observed.

It is further object of the invention to provide an interface from a transducer for string vibrations to a musical instrument digital interface (MIDI) control signal.

In order to accomplish these and other objects of the invention, a vibration transducer is provided comprising a source of substantially collimated light, a photodiode having a limited light reception angle corresponding to width of a light beam emitted from the source of substantially collimated light, a board for mounting the light source and the photodiode in a generally coaxial orientation, and an amplifier circuit having a transimpedance configuration.

In accordance with another aspect of the invention, a converter for converting a pitch frequency to a MIDI control signal is provided comprising an analog to digital converter, a fast Fourier transform processor, a peak detector, and a look-up table for correlating a frequency of a peak detected by the peak detector to an identification of a musical note.

In accordance with a further aspect of the invention, a signal converter for converting an analog waveform into a digital code is provided comprising a plurality of neural networks connected in cascade and receiving a spectrum of said waveform as an input, wherein each of said plurality of neural networks provides a binary classification of a frequency component of said spectrum of said waveform.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a graphical comparison of the free vibration of an excited string of a musical instrument with the vibration of the string when damped by the magnetic field of an electromagnetic transducer,

FIG. 1A is a schematic diagram of an equivalent model of a photodiode suitable for the practice of the invention,

FIG. 2 is a cross-sectional view of a sensor module in accordance with the invention suitable for installation on a guitar,

FIG. 2A in a schematic overview of a preferred form of the optical transducer in accordance with the invention,

FIG. 3 is an oblique view of a portion of a guitar including the transducer module in accordance with the invention installed thereon

FIG. 4 is a schematic diagram of the modular transducer in accordance a preferred embodiment of the invention,

FIG. 5 is a graph of the time response of the optical transducer in accordance with the invention,

FIG. 6 is a graph of the frequency response of the optical transducer in accordance with the invention,

FIG. 7 is a graph of the frequency response of the analog interface in accordance with the invention,

FIG. 8 is a graphical comparison of the harmonic series produced by an optical transducer in accordance with the invention and a conventional electromagnetic transducer,

FIG. 9 is a high level block diagram of the overall signal conversion processing performed by the interface in accordance with a first embodiment the invention,

FIG. 10 is a high-level block diagram of signal pre-processing performed by the interface in accordance with a second and preferred embodiment the invention,

FIG. 11 is a schematic depiction of the operation of the cascaded neural network in accordance with the invention,

FIG. 12 is a block diagram of the feed-forward neural network topology in accordance with the invention,

FIG. 13 is a graphical depiction of target output and estimated output of the cascaded neural network,

FIG. 14 is a confusion matrix illustrating a high percentage of correctly predicted classes produced by the invention,

FIG. 15 is a table of statistics illustrating the sensitivity and specificity of the neural network in accordance with the invention,

FIG. 16 is a table illustrating the percentage of misses for single and concurrent misses of pitch prediction produced by the invention, and

FIG. 17 is a table illustrating execution time of the neural network compared to other benchmarks corresponding to other pitch detection techniques.

### DETAILED DESCRIPTION OF A PREFERRED EMBODIMENT OF THE INVENTION

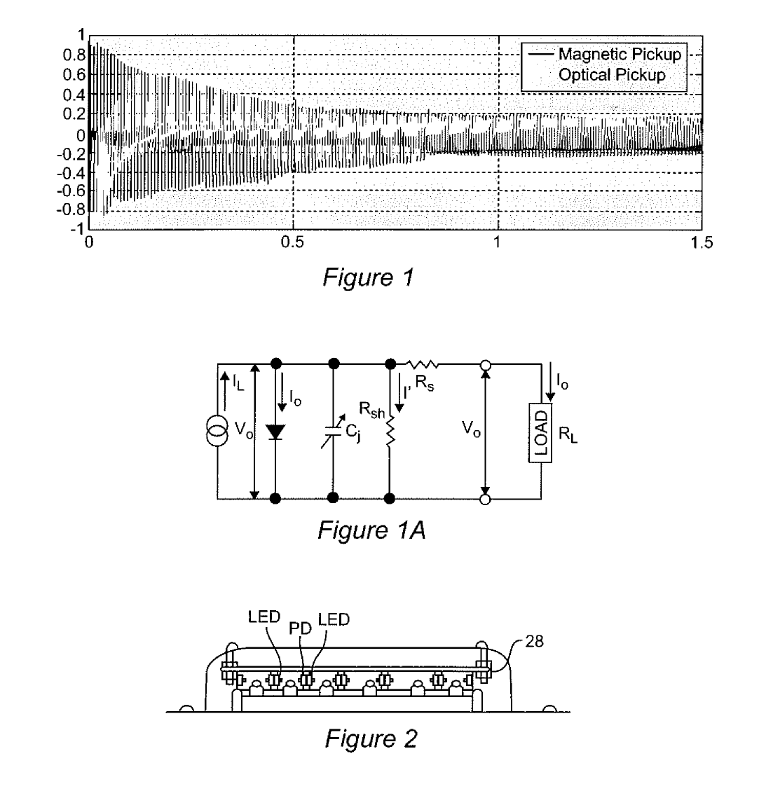

Referring now to the drawings, and more particularly to FIG. 1, there is shown a graphical comparison of the response of an electromagnetic transducer and an optical transducer in accordance with the invention to vibrations of an excited string of an exemplary musical instrument such as a guitar. This comparison is particularly illustrative of the damping caused by the attraction of the vibrating string as it moves through a magnetic field. It can be readily seen that the amplitude of oscillation is much smaller in the case of the electromagnetic transducer and includes a very low frequency oscillation component that would be audibly observed as a distortion of the sound produced whereas the vibration of an excited string which is not damped by a magnetic field is substantially larger and symmetrical about the rest position of the string and decays in amplitude much more slowly. Therefore, an optical transducer is comparatively much more desirable than and electromagnetic transducer, particularly in regard to preserving subtle sound qualities of a string instrument. However, as alluded to above, attempts to develop an optical transducer have not been successful due to the frequency response of phototransistors and the susceptibility of phototransistors to interference from ambient light conditions.

Referring now to FIG. 1A an equivalent circuit model of a photodiode is shown. Photodiodes are used in a variety of sensing applications such as distance and proximity sensors, object counters, and high-speed photometry. They can be fabricated from a variety of semiconductor materials including Si, Ge, GaAs, InGaAs, and InGaN, and many include an intrinsic layer creating a P-I-N structure semiconductor. Electric photodiodes convert light intensity into current linearly and for audio purposes have unlimited bandwidth. A drawback to photodiodes is they have a built-in capacitance (see FIG. 1) which determines response speed and requires careful choice and tuning depending on application. Another drawback of photodiodes is that, generally, the current produced is very small and changes in that current with incident light intensity are difficult to detect. Therefore, choice of a photodiode for a vibration sensor that must also have a rapid response speed and cover a wide range of frequencies is highly counter-intuitive.

To make a photodiode useful as a vibration sensor that must be able to track a wide range of frequencies, its output current must be converted into a voltage that is large enough, in the case of a guitar string transducer, to drive a guitar amplifier. Using an operational amplifier in a transimpedance configuration can achieve this goal, and with careful selection of the amplifier, the current to voltage conversion can be achieved at high speeds and over a large bandwidth.

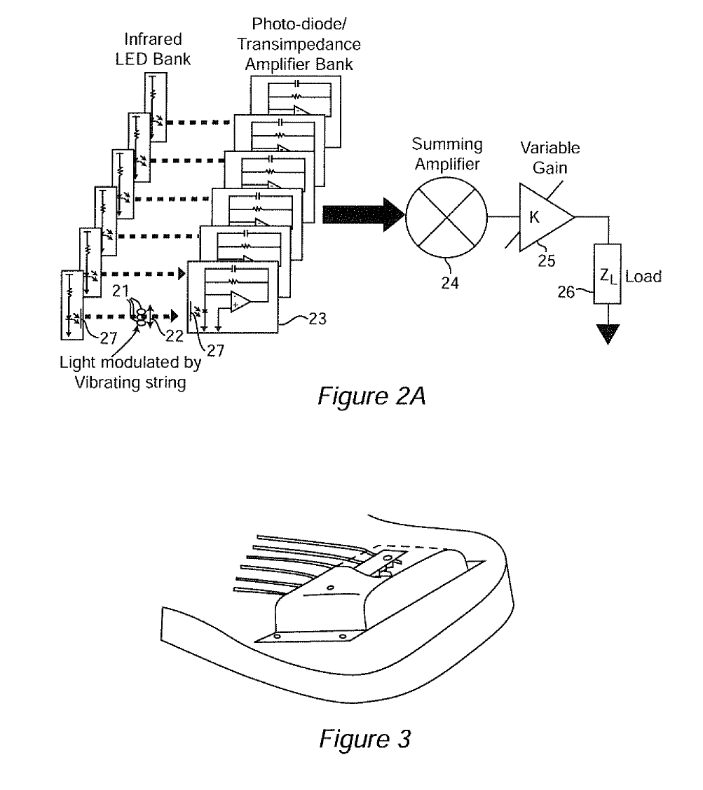

Since the sensor will be used for audio purposes, component selection with respect to noise, bandwidth and response speed is relatively critical. However, photodiode having sufficient response speed and bandwidth are commercially available. Generally, noise can be limited and gain and responsiveness enhanced by choice of a photodiode have a viewing angle that corresponds closely to the diameter of a string with which it is associated at a given small distance. If the viewing angle is too small, small vibrations will not modulate the light (e.g. the light from a light source will always be blocked) and if too large, there will be some level of constant illumination whether the string is vibrating or not and the changes doe to vibration will be relatively smaller and even more difficult to detect. additionally, improved resistance to interference from ambient light can be provided by spectral filtering to a given band of optical wavelengths as depicted at 27 of FIG. 2A.

In general, a photodiode should be chosen to have a response time of less than 0.30 μsec or as dictated by the upper end of the range of frequencies to be detected. Also, at the present time, a monolithic module (illustrated at 23 of FIG. 2A) combining a photodiode and a transimpedance configuration amplifier is commercially available; rendering the characteristics of the photodiode, itself, substantially less critical and response speed requirements substantially more easily satisfied as well as providing stabilization to the operation of the photodiode. Other specifications of commercially available photodiode which have been found suitable for practice of the invention are:
irradiance responsivity>111 mV (mW/cm²) at 940 nm wavelength
Dark voltage<10 mV
Response time<260 nanoseconds
output noise voltage<10 μV²/(Hz).

Since one of the problems with traditional magnetic pickups is noise and a non-linear frequency response, it is important to not create or allow unnecessary sources of noise and distortion to be created by circuitry components peripheral to the photodiode. By using a light source (e.g. a light=emitting diode or LED) coupled to a photo-detector (photodiode) PD in a “line of sight”, generally coaxial configuration as shown in FIG. 2, a simple optical transducer can be implemented by using the guitar string's vibration to modulate the amount of light seen by the photo-detector as illustrated in greater detail in FIG. 2A.

An excited string will usually vibrate with an amplitude comparable to its own diameter or greater as depicted at 21 and arrow 22 of FIG. 2A. Therefore, if the light beam width is similar to the diameter of the string, the amount of masking of the photodiode by the string as it oscillates will modulate the current produced by the photodiode. The light source and photodetector can be arranged in back-to-back pairs, as illustrated, or in other configurations such as pairs of back-to-back pairs of light sources alternated with back-to-back pairs of photodiodes, in a very compact configuration significantly smaller than the transverse dimension of a human finger that also dictates the spacing of strings of most musical instruments. Instruments having groups of correspondingly tuned strings such as are found on a piano, twelve-string guitar or bouzouki can have angled “lines-of-sight” or other configurations to allow individual strings to be monitored while the transducers can still be inserted and suspended between groups of strings.

The transducers mount comprises a U shaped bracket that is affixed atop the guitar or other instrument over the strings at a desired location along the strings but preferably close to the bridge that secures one end of the strings. The location along the strings is important in that the harmonic content of the vibrational modes of the string will be greater toward the end of the string whereas the fundamental frequency component will be increased farther from the nut. The circuit board is mounted in the mount allow the photodiode and light-source to hang between each string when the modular transducer is mounted on the musical instrument as indicated in FIG. 3.

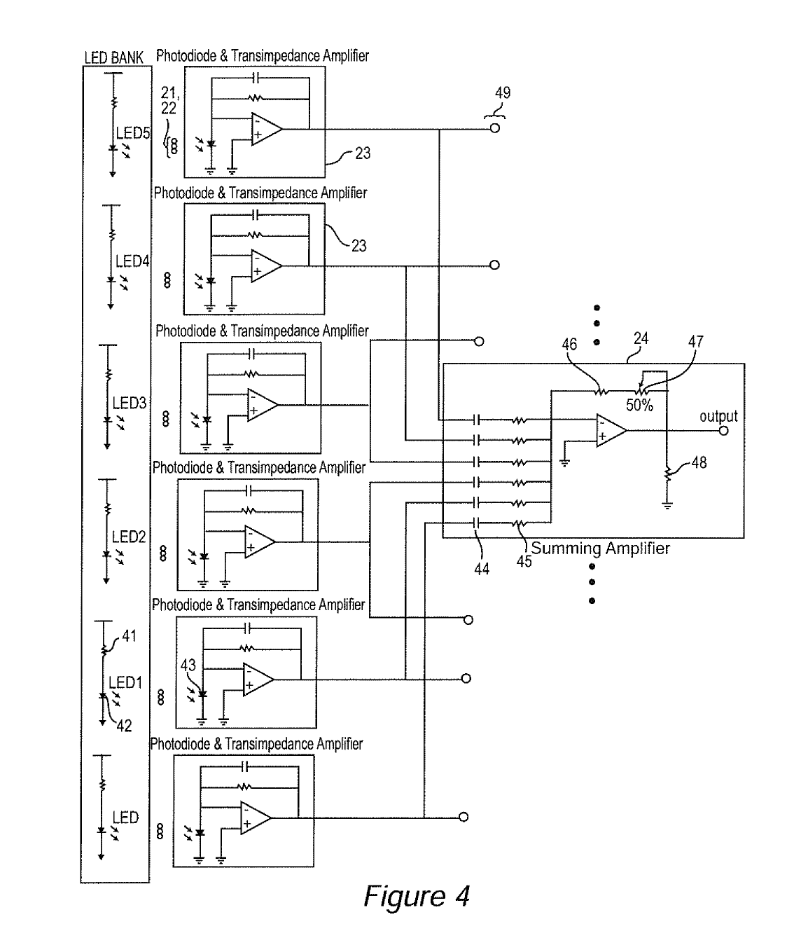

A schematic diagram of the circuitry of the modular transducer is illustrated in FIG. 4. It will be noted that six channels are provided corresponding to the six strings of a traditional guitar. More or fewer channels can be provided as may be appropriate for other stringed instruments to which the invention can be applied. Resistors 41 limit and control current through LEDs 42 or other light source and thus regulate the light flux emitted by the light sources to a desirable level. As previously indicated, the light flux received by photodiodes 43 will be modulated by the vibrational movement of respective strings, as indicated at 21, 22. the transimpedance amplifiers in each channel comprise an operational amplifier with the inverting input connected to the photodiode and a feedback circuit comprising a resistor and capacitor connected in parallel. The arrangement inverts the (negative) current flowing from the amplifier input through the photodiode causing a voltage to appear at the output which corresponds to the modulated light flux incident on the photodiode.

The outputs of all of the channels are then connected through a mixing or summing amplifier through a series connected resistor 45 and capacitor 44. The relative values of resistors 45 determines the relative gain of the respective channels while the capacitors 44 serve to filter low frequencies (e.g. below the frequency that can be produced by the corresponding “open” (e.g. full length) string. Resistors 46, 47 and 48 (collectively depicted at 25 of FIG. 2A) serve to adjust gain of the mixing or summing amplifier 24. It should be noted that more than one mixing or summing amplifier may be provided for individual or combinations of outputs 49 of the respective channels. The individual channel outputs can also be used for other purposes as will be discussed below.

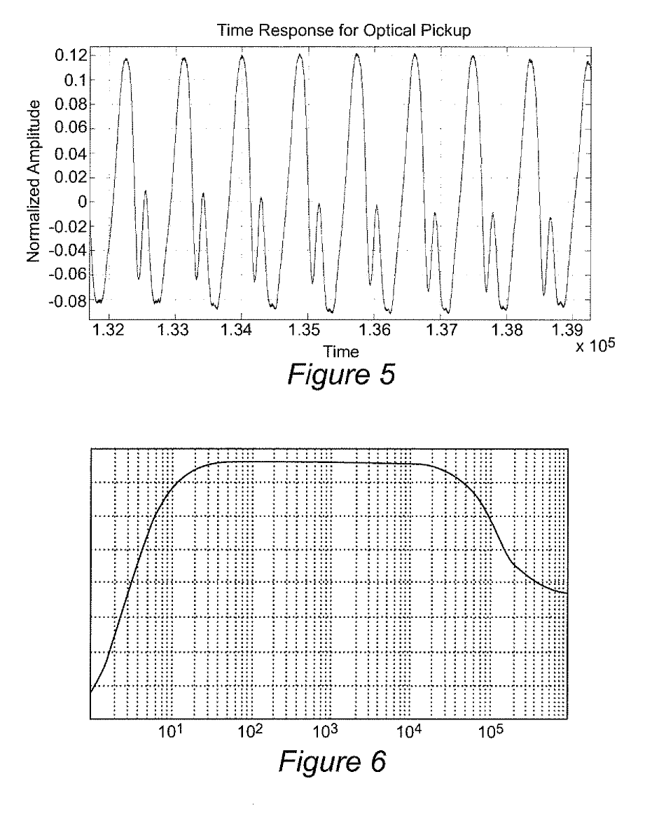

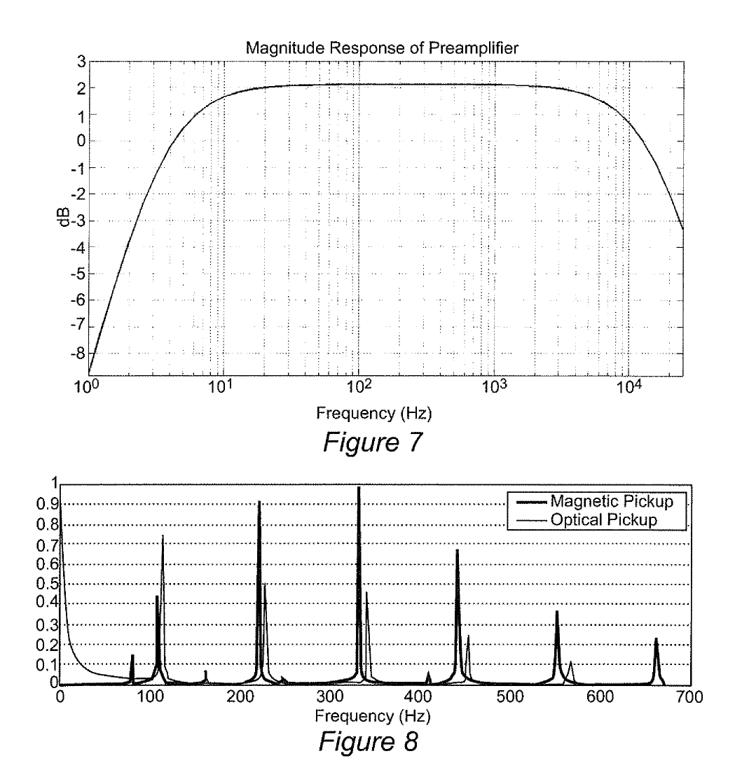

Thus, the optical transducer converts individual string vibrations into an electrical signal by modulating a light source incident on a photodiode. Traditionally, string vibrations are converted to an electrical signal by modulating the magnetic field of a magnetic transducer. Use of a photodiode in combination with an impedance-controlling amplifier stage has several improvements over traditional magnetic transducers. As alluded to above, magnetic transducers have a non-linear frequency response, whereas the optical transducer using a combination of a photodiode and an impedance controlling amplifier stage has a rapid response as shown in FIG. 5 and a flat frequency response in the audible range of frequencies (e.g. up to near 10⁵ Hz—well beyond the range of human audibility) as shown in FIG. 6. The frequency response of the amplifier stage, as shown in FIG. 7, preserves the flat frequency response of the photodiode. A comparison of the harmonic series frequency response of the modular transducer in accordance with the invention and the response of an exemplary magnetic transducer is shown in FIG. 8. It should be particularly noted in FIG. 8, depicting a fundamental frequency of about 110 HZ, the amplitude of the harmonics (e.g. peaks) diminishes smoothly from the amplitude of the fundamental frequency (as would be expected) for the optical transducer whereas the third harmonic, at about 330 Hz, is largest with the fundamental frequency and other harmonics substantially diminished therefrom for the electromagnetic transducer.

Magnetic transducers are also susceptible to hum from the electromagnetic field produced by the power mains, while the optical transducers are not. One last advantage over magnetic transducers is that, while magnetic transducers dampen the vibrations of the strings by magnetically pulling on the metal string of a guitar, optical transducers allow a string to vibrate naturally as shown in FIG. 1, discussed above. The comparable deficiency of optical transducer susceptibility to ambient light is solved by the modular configuration in accordance with the invention in which the light from the light emitters is preferably well-collimated, the reception angle of the photodiode is limited, optical shielding is provided by both the circuit board and the U-shaped bracket of the invention and optional spectral filtering 27, alluded to above.

This design also differs from current optical pickups by using photodiodes instead of phototransistors, which allow for a linear frequency response. This property allows for the analog signal to easily be converted into a digital signal, which current systems do not possess. The design can also be and preferably is manufactured as a modular system that can be mounted on virtually any guitar or other string instrument with little, if any, modification of the instrument. The optical transducer in accordance with the invention provides a far more natural sound with high fidelity to the string instrument, itself, with which it is used and provides a far cleaner signal in regard to pitch with little distortion at frequencies other than the natural vibrational modes of the string in the environment of a particular instrument.

For control of a music synthesizer, in addition to the controls of the waveform and envelope applied to the notes, a signal identifying the specific pitch or pitches of the notes to which such controls are to be applied is required. Arrangements for automatic music transcription have much the same requirements for input of pitch information. A piano-type keyboard is generally used to provide such signals since such a device provides a separate individual switch for each pitch to be produced. However, most types of musical instruments do not provide such a unique correspondence between elements of the instrument and the pitch to be produced. With string instruments, in particular, even though the vibrational length of an individual string may be determined by the user pressing a portion of a given string against a fret with which a switch could theoretically be associated, a given fret will correspond to a plurality of strings (six for a traditional guitar) that are tuned to different pitches and, moreover, different or unconventional tunings of individual strings may be used. Therefore, if a stringed instrument is to be used to control a music synthesizer, signals indicative of particular pitches must be derived from the pitch acoustically produced by a string.

Pitch detection is one of the oldest and most studied problems in musical signal processing. Many methods have been proposed ranging from time domain, frequency domain, and statistical techniques.

An important application is pitch to MIDI (Musical Instrument Digital Interface) control signal conversion. MIDI is a digital control protocol typically used to control both analog and digital music synthesizers such as electronic keyboard instruments sometimes referred to simply as keyboards. Pitch to MIDI control signal converters must take an analog signal, such as a output from an electric guitar, and perform some process in order to estimate the fundamental frequency of the note being played and relate one of the 128 notes in the MIDI protocol (a range of almost eleven octaves) to that frequency. Fundamental frequencies can very often be weaker than higher order harmonics or missing altogether in the output of magnetic transducers, as discussed above in connection with FIG. 8, leading to errors in peak detection.

In this regard, substantial challenges are presented by the form of the distribution of musical notes with respect to frequency. Musical notes are logarithmically distributed such that the frequency of musical notes is doubled or halved with each octave above or below a given note, respectively. Adjacent chromatic tones differ from each other in frequency by only slightly more than 5%. Thus, low pitches are only a few hertz apart while high pitches are hundreds of hertz apart. This requires frequency domain techniques to have a large block size to obtain a sufficient resolution at low frequencies, which is computationally expensive. One method has been used to linearize the pitch distribution by taking the Fast Fourier Transform of the logarithm of the transformed signal; this is known as Cepstrum analysis. Again this proves to be computationally expensive. Perhaps more importantly in the context of real time performance of music, unless substantially greater processing power is available than could be provided by a personal computer of current design, computationally intensive processing causes audibly detectable delays that are highly objectionable.

Several methods have been proposed that use artificial neural networks as some form of pitch estimator. They are typically concerned with detecting pitch in prerecorded music for music database analysis and automatic transcription processing where response time is relatively unimportant. Neural networks can also be highly processing intensive.

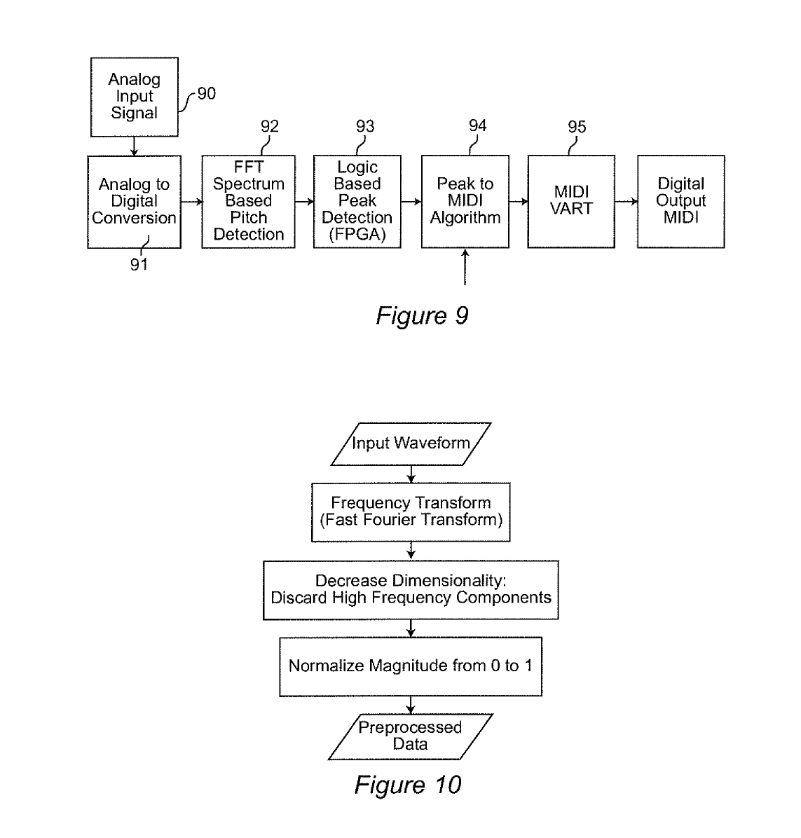

The invention provides a pitch to MIDI control signal conversion which accommodates polyphonic (e.g. detection of plural simultaneous pitches) conversion quite easily in the case of stringed instruments such as a guitar. Specifically, referring to FIGS. 9 and 4, the raw transducer outputs 49 for each string, as depicted at 90 of FIG. 9, can be connected to a six channel analog to digital converter as depicted at 91 of FIG. 9. The spectrum of the vibration of each string is then determined, preferably using a fast Fourier transform (FFT) from the resulting digital data as depicted at 92. The data representing the spectrum is then fed into a spectrum based pitch detector, preferably embodied in hardware description language (HDL) and preferably programmed on a field programmable gate array (FPGA). The FPGA allows for parallel concurrent processing of the pitch detection for each of the strings of the instrument. If the optical transducer described above is used to monitor the vibrations of respective strings, the largest peak will be the fundamental frequency as noted above in connection with FIG. 8, and can be detected with simple logic as depicted at 92 and other spectral peaks discarded as depicted at 93. (For this reason, output of a magnetic transducer cannot be used with this embodiment of the invention without prohibitive logical complexity.) In the same logical peak detection operation, the note corresponding to the fundamental frequency is also identified by a conversion using a look-up table correlating nominal frequencies of each possible not with an identification (e.g. A440, middle C, etc.) of the note as might otherwise correspond to a given key of a piano keyboard. The look-up table is also preferably provided by the FPGA. The note identifications can then be easily converted to MIDI control signals by a simple conversion algorithm as depicted at 94. These two conversions can also be performed as a single conversion process, depending on how the FPGA is programmed. Then, optionally, the MIDI control signal can be transmitted to an amplification system using a universal asynchronous receiver transmitter (UART) or other short range communication system to allow avoidance of a hardwired connection that would otherwise tether the performer to the amplification system. Thus, the entire device in accordance with this first embodiment of a pitch to MIS+DI converter can be implemented on a six channel A/D converter and one FPGA and is thus sufficiently small to be included with a small battery as a power supply on board 28 illustrated in FIG. 2.

As indicated above, this first embodiment of a pitch to MIDI converter has the advantage of being small while allowing polyphonic pitch to MIDI conversion and being sufficiently small to be included in the modular optical transducer described above. However, at the present state of the art, response speed is deemed somewhat marginal in the prototypes constructed to date.

Much more rapid response speed for pitch to MIDI conversion is provided by a second embodiment of a pitch to MIDI converter which will now be described. The neural network method proposed in this second and currently preferred embodiment has several advantages over traditional methods. The first and most important advantage is that searching for a specific frequency or period is not necessary since the network is trained to recognize relationships between all data points in a single block to classify the data. Due to this the quality of the frequency spectrum is not as high as it would be for traditional methods; this allows processing time to be faster. Another advantage over tradition methods is the natural parallel structure of neural networks that can allow for efficient implementation on hardware or FPGA (Field Programmable Gate Array) devices, though because of the computational efficiency of the networks common microcontrollers or DSP devices are typically suitable.

To estimate pitch with high accuracy within a response time that is not audibly detectable, the invention provides a cascaded feed-forward back-propagation neural network whose inputs consist of the frequency spectrum of a guitar input. This method is based on the idea of intelligent neural networks that have the property of being more accurate than traditional neural networks. Intelligent neural networks are cascaded neural networks that first classify an input to a group of possible outputs and continue to reclassify the input to smaller groups until only a few possible outputs remain that the input may belong to. The cascaded neural network in accordance with the invention is unique in that it is based on a power of two decision so that the groups of possible outputs are segmented using only a power of two (32, 16, 8, etc), so that all decision including the final decision is binary. Ten-fold cross validation was used for training a network selection to insure the network model was appropriate and no over fitting has occurred.

FIG. 10 shows three preprocessing steps, which are as follows: transform from time-domain to frequency-domain via the Fast-Fourier Transform (FFT), dispose of high order harmonic content to decrease dimensionality, and then normalize the result. The FFT is used to obtain the frequency spectrum over a short window in time, in this case represented by one input block. A Bin size of 1024 is used when calculating the FFT with a sliding window of 256. Since most of the output samples of the FFT are related to high frequency components with magnitudes close to zero only the first 64 samples of the original 1024 are kept and used as inputs to the neural networks. Discarding the majority of the data allowing the dimensionality of the input space to the neural network to be greatly reduced. This allows for greater efficiency with respect to propagation of data through the network. Since frequency spectrums are typically calculated using the magnitude of a frequency transform the data is normalized with its minimum value being zero and minimum value being one. After normalization, the data is ready to be processed by one of the neural networks.

Cascaded neural networks in accordance with a preferred embodiment of the invention are artificial neural networks arranged so that multiple networks are used to make a single decision. This model is also known as an intelligent neural network system whose goal is to simplify a complex classification by grouping the input space into several simple classifications. The overall structure of the cascaded neural network as shown in FIG. 10 illustrates the flow of data through the networks.

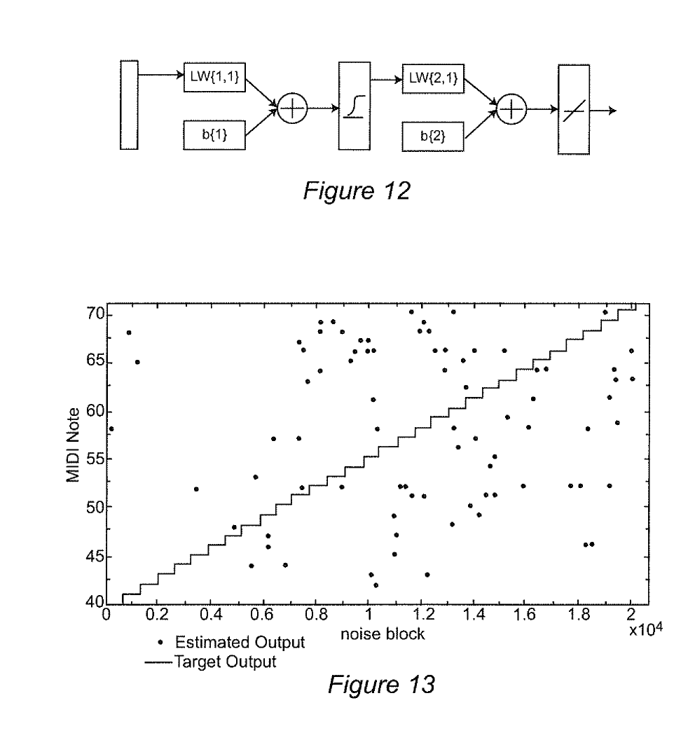

Specifically, each neural network within the cascaded system is of the feed-forward topology shown in FIG. 12 and the transfer function of which can be seen in equation (1):

a²=f²[LW_{2,1}f¹(IW_{1,1}+b₁)+b₂] (1)

where a2 is the output of the network, f1, f2 are activation functions, LW2,1 is the hidden layer weight matrix, IW1,1 is the input layer weight matrix, b1 and b2 are biases, and p is the input vector. Both activation functions map the output from the multiplication by the weight matrices to an output constrained typically between one and zero but many time an unconstrained function may be used such as linear or exponential. Typically a sigmoid curve is used for an activation function. However, in accordance with the invention, a saturated linear function defined in equation (2)

$$f ( n ) = \{ \begin{matrix}0 , & if n < 0 \\ i , & if 0 \leq n \leq 1 \\ 1 , & if n > 1\end{matrix} \qquad ( 2 )$$

is used for the hidden layer activation function. This is because it is a close approximation to the typical sigmoid function and is more computationally efficient since it can be represented by a simple condition statement while a sigmoid function is typically represented by a large lookup table. A purely linear activation is used on the output.

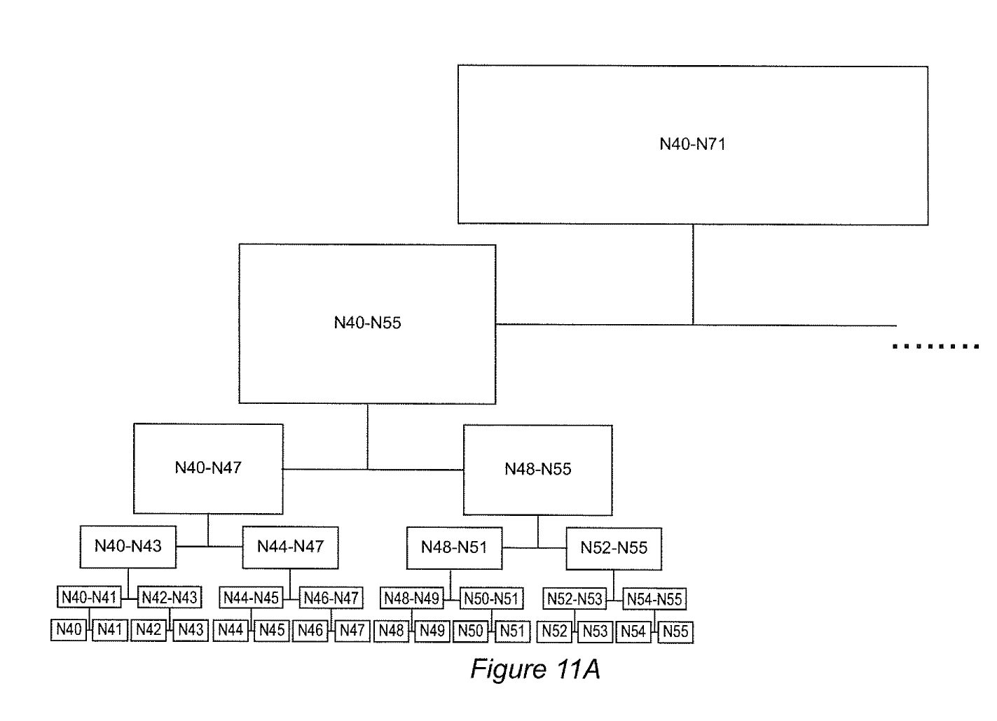

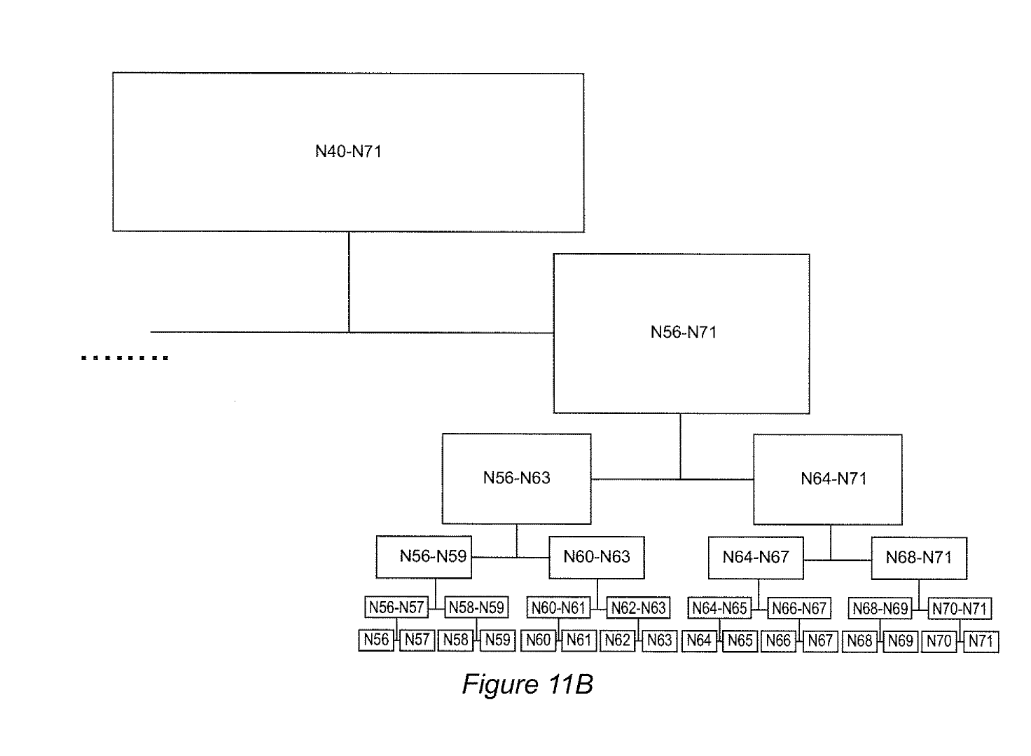

Each network takes in an input vector represented by the frequency spectrum obtained during preprocessing shown in FIG. 9 and produces a zero or one as the output based on what frequency range the input note falls into. As the input propagates through each network, each classification is between fewer and fewer notes until the final network only has to choose between two possible notes. In terms of this particular system there are thirty-two possible choices of notes (two and two-thirds octaves) which is deemed sufficient for the notes that can be produced by a given string of virtually any string instrument. Other numbers of MIDI notes are, of course possible as may be deemed convenient. The first network classifies notes into either the lower sixteen or upper sixteen possible notes, depending on the outcome of the first network (low frequency or high frequency) the next network splits the now 16 possible notes into two groups of low and high frequencies. This continues until only two notes remain, as illustrated in FIG. 11. The output of the system represents the MIDI note to which the input corresponds. The final selection will be between two chromatically adjacent notes and a decision can be made as to whether the frequency more closely corresponds to a nominal range of frequencies corresponding to either note. By restraining each neural networks output to a binary decision network complexity is greatly reduced with the advantage of increased accuracy due to the fact each network is only responsible for a small part of a larger task. This simplification also greatly enhances response speed.

The data used to train and test both artificial neural networks were acquired from notes played on a guitar and recorded at a sampling frequency of 44.1 kHz with a 24-bit depth. Thirty-two notes ranging from note E-2 (82.4 Hz, MIDI note 40) to note D 0 (493.9 Hz, MIDI note 71), were chosen to train and test the network. Each note is recorded for approximately four seconds with varying strumming intensity and speeds to give the data a wide range of transient behavior. The data was then segmented into block sizes of 1024 samples with a sliding window of 256 and organized in a large input matrix for preprocessing.

Training for all networks is performed using the Liebenberg-Marquardt back-propagation training routine in the MATLAB™ Neural Network Tool Box. This routine is designed to be able to approximate the Hessian while approaching second order training speeds. This training method was chosen due to the ease of implementation in the MATLAB™ programming environment in addition to being well-documented as the fastest training algorithm for neural networks of moderate size.

When training each network the data is split into training, validation, and testing sets. The training set is used to train the network while the validation set is used to estimate the performance of the network during training and, finally, the testing set is used to evaluate the performance of the network, once trained. Typically data is randomly split into these sub-groups and the network is trained.

Ten-fold cross validation is a method used to systematically split data between training, testing, and validation groups and insure the network model is suited to its intended task as well as assuring the network has not been over-fit to the data. In ten-fold cross validation the data is split into ten folds (e.g. given divisions of a full set of date) with training data assigned to eight folds, validation data assigned to one fold, and testing data to one fold. The network is then trained on the data set using the ten-fold split. Once training is complete the data is circularly shifted through the ten folds and a new network is trained. This continues until all data has been used for training, validation, and testing on independent networks. Once all networks have been trained their individual performance maybe compared to each other. This allows one to see if the network model chosen is suitable for the application by seeing little variation in the performance of each network. Additionally, this allows one to choose between ten trained networks for the user's final application.

Several statistical measures can be applied in order to measure and illustrate the performance of the cascaded neural network as a pitch detector. These measures are not only for showing good performance but also gives insight on choosing the best network as discussed above. Measures of sensitivity and specificity are used to evaluate each binary network. Where sensitivity illustrates the networks ability to identify positive results, this is mathematically shown in equation (3). Specificity is the measure of how well the network can classify negative results as in equation (4).

$$\begin{matrix}sensitivity = \frac{true positives}{true positives + false negatives} & ( 3 ) \\ specificity = \frac{true negatives}{true negative + false positivies} & ( 4 )\end{matrix}$$

A classification having high sensitivity and specificity shows a network has been well trained and suited to classifying data.

The cascaded neural network was implemented on an Analog Devices SHARC ADSP-21469 Digital Signal

Processor (DSP). The SHARC DSP is a fourth generation floating point processor capable of clock speeds of 450 MHZ or 2700 MFLOPS [9]. All operations were done using floating-point arithmetic. Though not used the SHARC DSP also features hardware accelerated FIR and IIR filters, as well as a hardware accelerated FFT core. Other processor could, of course, be used. The particulars of the above equipment is provided to indicate the scope of processing resources which are suitable for practice of the invention.

All functions were programmed in C with minimum optimization to illustrate the high efficiency of the system. Benchmarks were performed using the Time.h header file functions. Although some overhead exists when using these functions, they provide a good indication of the speed of the system.

The neural networks chosen for evaluation were chosen based on the network that best classified the data. These networks were trained using ten-fold cross validation as described above. This provided not only proof that the neural network has correctly classified the input signal but also provided multiple independently trained networks to choose as the network to use in the final implementation in an embedded environment.

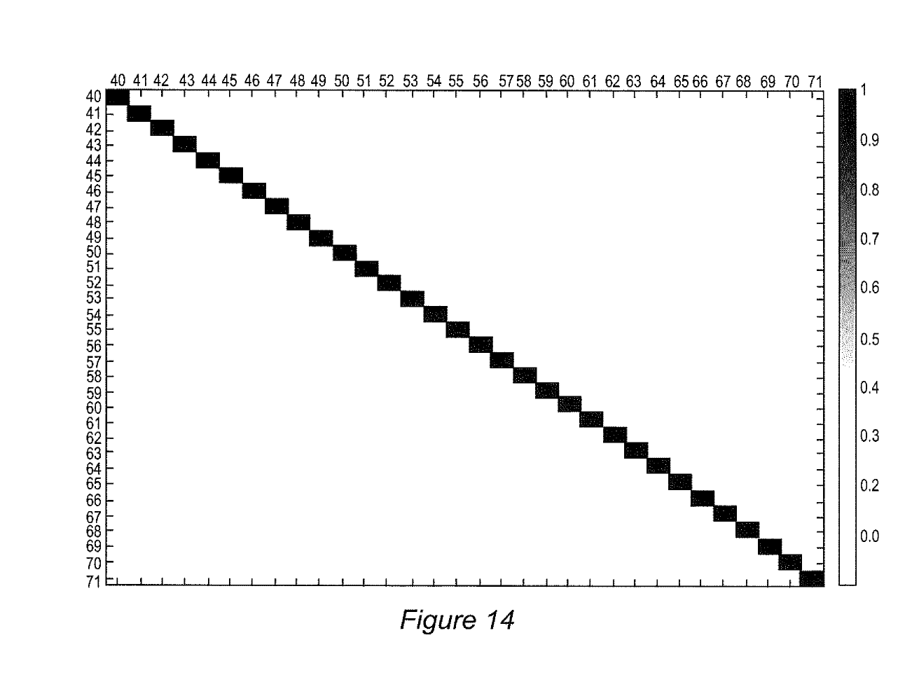

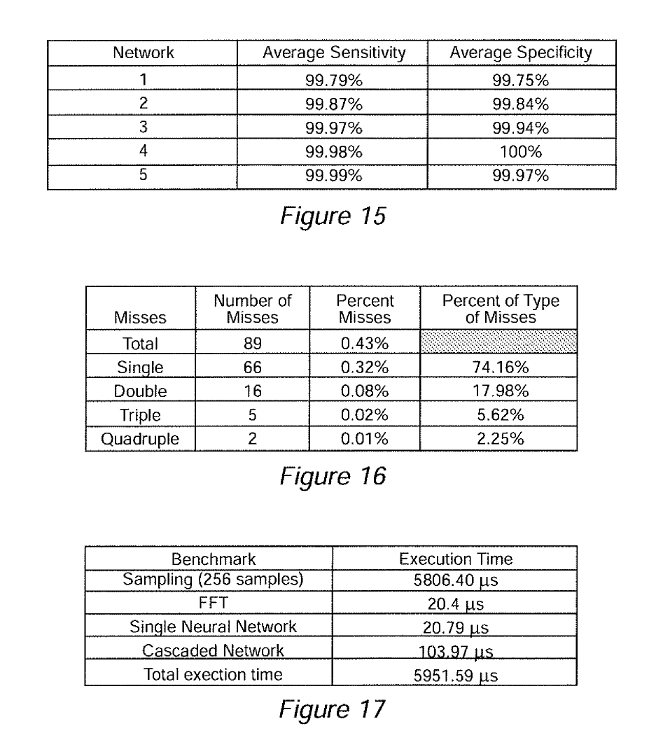

The results showed a highly accurate classifier could be realized through cascaded neural networks with a frequency spectrum input. It can be seen in FIG. 13 that the majority of the estimated outputs fall along the target line showing that the majority of the data is correctly classified. This accuracy is further illustrated in the confusion matrix in FIG. 14 which shows that the majority of the predicted note values correspond to the target values. Because there are so few notes incorrectly classified they do not even appear in the confusion matrix plot. Performance measures for the networks proved to meet expectations of the cascaded network being highly accurate classifier with both sensitivity and specificity for each network level being nearly 100% as shown in FIG. 15. Finally. FIG. 16 statistically illustrates the performance of the cascaded network showing the overall percentage of misses is extremely low with the majority of misses being sparse. That is, an incorrectly classified note is not followed by another incorrectly classified note. Multiple misclassified notes account for approximately 25% of all misclassified notes or approximately a tenth of a percent of the misses.

The cascaded neural networks performance on an embedded system proved promising. The benchmarks shown in FIG. 17 show impressive execution times with a total execution time of approximately 5.95 milliseconds with the cascaded network executing in only 0.10 milliseconds. A delay of this duration is not audibly perceptible.

In view of the foregoing, it is seen that the invention provides a robust and modular optical transducer for sensing vibration in any vibrational system and which is particularly suitable for use in connection with string musical instruments and which provides good sensitivity to and preservation of subtle qualities of the sound produced by the instrument. The modular transducer can be easily applied to virtually any musical instrument and can be conformed to virtually any array of strings even when the strings are not coplanar. For example, the U-shaped bracket discussed above in Connection with FIG. 2 can be curved to conform to the strings of, for example, a violin. Alternatively, the light sources and photodiodes can be suspended at different distances from the boar on which they are mounted for access to, for example, drone strings that may be located under the strings that are actively played. The invention also provides a computationally feasible and accurate method for pitch detection aimed at use for a guitar pitch to MIDI interface based on cascaded artificial neural networks with a frequency spectrum input. It was shown that high accuracy of pitch estimation could be rapidly achieved through binary decisions in the cascaded neural network tree by first making a broad classification to which group of notes the input signal belonged to, and repeat this until the classification is only between two notes. Because the classification process is based on broad decisions, the weight matrices of the artificial neural network were able to be made small and still produce accurate results. It was also found that a small Fast Fourier Transform bin size could be used since low frequency accuracy is not required. This is due to that fact the neural network's classification is based on the relationship between all the samples in the FFT spectrum. The ability to use small sized networks allows for real time computation speed on an embedded system. In addition to computationally efficient neural networks, efficiency was also aided by the minimal need for preprocessing.

The cascaded neural network pitch detector was implemented on an Analog Devices fourth generation digital signal processor capable of floating point arithmetic. This device is typical of what is found in consumer music performance devices. Even with code that has not been optimized, the cascaded neural network well exceeds expectations for real-time use. Current research has shown the methods for monophonic pitch detection discussed above are also well suited for polyphonic (multiple note) pitch detection. The challenges to overcome when working with cascaded neural networks in a polyphonic setting include the exponentially larger training data set needed to represent all combinations of notes as well as developing an effective control system to correctly select the group of notes (chord) being played.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A vibration transducer comprising
a source of substantially collimated light,
a photodiode having a limited light reception angle corresponding to width of a light beam emitted from said source of substantially collimated light,
a board for mounting said light source and said photodiode in a generally coaxial orientation, and
an amplifier circuit having a transimpedance configuration.

2. A vibration transducer as recited in claim 1, wherein said light emitter and said photodiode are aligned with an element that can vibrate.

3. A vibration transducer as recited in claim 2, wherein said element that can vibrate is a string of a musical instrument.

4. A vibration transducer as recited in claim 3 further including a U-shaped bracket for supporting said board.

5. A vibration transducer as recited in claim 4 wherein said musical instrument has a planar array of strings and said board and/or said U-shaped conform to said planar array of strings.

6. A vibration transducer as recited in claim 5, wherein said U/shaped bracket is of an extent to provide a degree of shielding of said photodiode from ambient light.

7. A vibration transducer as recited in claim 1 further including spectral filtering in a light path between said light source and said photodiode.

8. A vibration transducer as recited in claim 1, wherein said light source is a light-emitting diode.

9. A vibration transducer as recited in claim 1 wherein said photodiode is one of a plurality of photodiode corresponding in number to the number of strings of a musical instrument.

10. A vibration transducer as recited in claim 9, wherein said plurality of photodiodes is six in number.

11. A converter for converting a pitch frequency to a MIDI control signal, said converter comprising
an analog to digital converter,
a fast Fourier transform processor,
a peak detector, and
a look-up table for correlating a frequency of a peak detected by said peak detector to an identification of a musical note.

12. A converter as recited in claim 12, wherein said look-up table is constituted by a field programmable gate array.

13. A converter as recited in claim 11, wherein said analog to digital converter is a multi-channel analog to digital converter.

14. A signal converter for converting an analog waveform into a digital code, said signal converter comprising
a plurality of neural networks connected in cascade and receiving a spectrum of said waveform as an input, wherein each of said plurality of neural networks provides a binary classification of a frequency component of said spectrum of said waveform.

15. A signal converter as recited in claim 14, wherein said neural networks are trained with monophonic data.

16. A signal converter as recited in claim 14, wherein said neural networks are trained with polyphonic data.

17. A signal converter as recited in claim 14, wherein said digital code is a digital code of a MIDI protocol.
